(19) United States
(12) Patent Application Publication
(10) Pub. No.: US 2008/0257829 A1
(43) Pub. Date: Oct. 23, 2008

(54) Method and apparatus for separating particles from liquids

(76) Inventor: Bill Rippetoe, Dallas, TX (US)

Correspondence Address: BILL RIPPETOE, SUITE 411, 14114 DALLAS PARKWAY, DALLAS, TX, 75254, US

(21) Appl. No.: 11/789,064

(22) Filed: Apr. 23, 2007

(51) Int. Cl. B01D 17/04

(52) U.S. Cl. 210/748; 210/209

(57) ABSTRACT

Method and apparatus for separating immiscible solid or liquid particles such as oil from a liquid-based mixture or emulsion. The apparatus consists of two spaced apart concentric elongated metal cylinders. The wall of the innermost cylinder contains a multiplicity of spaced apart radially bored holes and its exit end is capped. The outer surface of the innermost cylinder and the inner surface of the outer cylinder consist of a ferrous metal coated with a titanium oxide and irradiated with ultraviolet light. Liquid is pumped under pressure into the innermost cylinder causing a multiplicity of jets of liquid to issue from the holes in the inner cylinder wall to bombard the titanium oxide coating of the inner wall of the outer cylinder. Electrons freed from the titanium oxide in the wall combine with both liquid molecules and particle molecules, causing the particles to separate from the liquid.

### FIELD OF THE INVENTION

The present invention pertains to a method and apparatus for separating immiscible solid or liquid particles such as oil from a liquid-based mixture or emulsion.

### BACKGROUND AND SUMMARY OF THE INVENTION

The known techniques for separating solid or liquid particles from a liquid-based mixture or emulsion include the following:

1. Decanting. Liquids having different specific gravities, i.e., oil and water, can be separated by standing in a settling tank. The lighter liquid floats to the top of the heavier liquid and can be skimmed off but it takes time for the liquid to settle. Moreover, skimming cannot avoid some water being mixed with the skimmed off oil. Typically skimmed oil contains about 15% water and the separated water about 50 parts oil per million parts water.
2. Centrifuging. Liquid or solid particles having higher specific gravities than the liquid base can be separated by spinning the emulsion in a rotating chamber whereby the heavier particles are separated by centrifugal force. Due to the weight of the spinning emulsion and the dynamic vibrations incurred, the equipment is both massive and expensive to operate.
3. Chemical Floccing. Floccing achieves separation of solid particles from a liquid by shifting the pH of the emulsion to impart an electric charge to the particles leaving both the particles and the liquid base negatively charged. Polymers carrying a positive charge are then added to the emulsion causing the negatively charged particles to draw together into a floc which can be removed from the liquid. Floccing is effective for only a narrow range of particles and once removed, the liquid must be purified.
4. Distillation. This method involves boiling the liquid and condensing the vapor. Distillation requires massive amounts of energy and is inefficient when the specific gravities of the liquid base and the solid or liquid particles are close together.

The present invention differs from the foregoing conventional methods of separating particles from liquid-based emulsions in that it not only provides rapid and inexpensive separation of the particles from the liquid but the resulting liquid has an extremely high level of purity.

The invention utilizes and combines several known scientific principles.

First, when a stream of liquid under pressure which contains solid or liquid immiscible particles is directed against the surface of a metal plate, the metal tends to give up electrons which then combine with the liquid molecules and with the particle molecules causing the similarly charged liquid and particles to repel and separate from each other.

Second, Titanium dioxide and titanium oxide, particularly in the anatase form, is a photocatalyst under ultraviolet light. Wherein anatase is one of the three mineral forms of titanium dioxide (the other two being brookite and rutile) wherein titanium has strong oxidative potential to oxidize water to create hydroxyl radicals when irradiated with UV light.

Third, titanium is a metal which readily gives up electrons and acts as a catalyst to enhance the breakdown of chemicals by oxidizing substances by making said substances give up electrons thereby breaking down organic chemicals.

The invention includes a unique device we have named an Ion Collider™. The Ion Collider combines the foregoing scientific principles into a remarkably effective method of separating immiscible particles from a liquid mixture or emulsion. In its simplest form the Ion Collider consists of two spaced apart concentric metal cylinders or pipes. Wherein both pipes are coated with titanium oxide preferably both the inner surface of the outer cylinder and the outer surface of the inner cylinder are coated with titanium oxide.

The wall of the inner cylinder contains a multiplicity of spaced apart radially bored holes and the exit end of the inner cylinder is capped. The opposite or entry end of the inner cylinder may have a filter screen to prevent entry into the Ion Collider of gravel or other large particles. The liquid is pumped under pressure into the inner cylinder causing a multiplicity of streams or jets to issue from the inner cylinder wall and bombard the inner surface wall of the outer cylinder.

The titanium oxide is exposed to ultraviolet light for photocatalyst irradiation affecting the fluids passing thru the Ion Collider with a strong oxidative potential to create hydroxyl radicals thereby creating hydrolysis, breaking down the water fluid into hydrogen and oxygen.

Electrons freed from the walls of the annular chamber between the two cylinders combine with both the base liquid molecules and the particle molecules, causing the particles to separate from the base liquid. The titanium oxide coating furthermore allows the remediation process to occur under ambient conditions.

### BRIEF DESCRIPTION OF THE DRAWINGS

The appended drawings illustrate a preferred embodiment of our invention and are intended to supplement the description of the invention in the text of this application.

FIG. 1 is a cross sectional plan view taken through the center of two co-acting Ion Colliders.

FIG. 2 is a cross sectional elevational view taken along line 2-2 of FIG. 1.

FIG. 3 is a cross sectional elevational view taken along line 3-3 of FIG. 1.

### DETAILED DESCRIPTION OF THE PREFERRED EMBODIMENTS

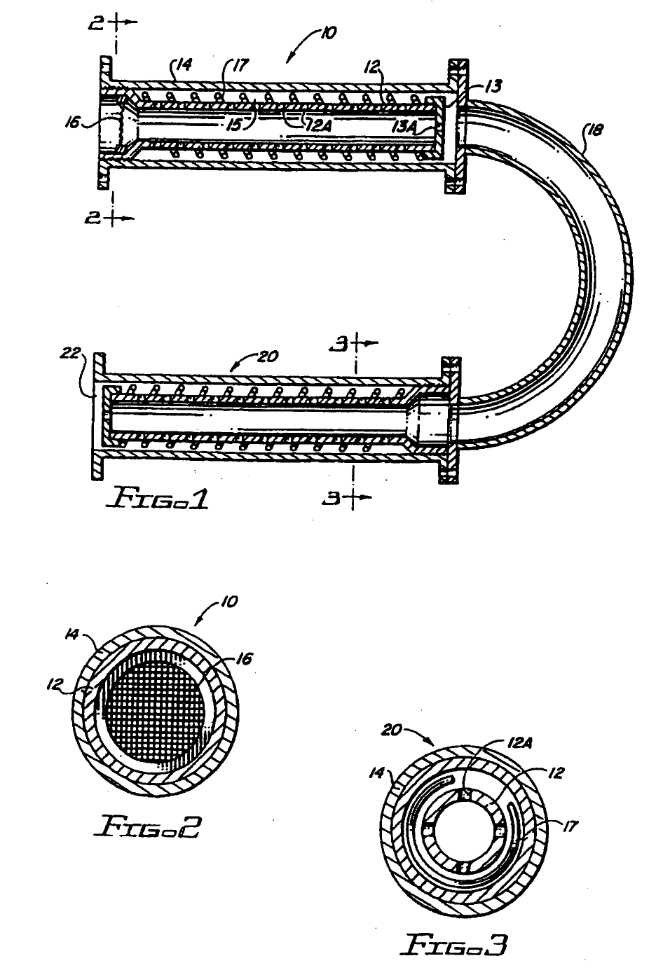

Referring to FIGS. 1 and 3 of the drawings, Ion Colliders 10 and 20 each include two spaced apart concentric elongated cylindrical metal pipes. Each of the pipes may be made of a ferrous metal and the outer surface of the inner pipe and the inner surface of the outer pipe coated with titanium oxide or an alloy of titanium dioxide, copper and nickel.

Inner pipe 12 contains a plurality of spaced apart radially bored holes 12A and its exit end is closed by a cap 13 which includes at its center a hole 13A. The diameter of hole 13A of the cap is slightly larger than the diameter of the plurality of holes 12A in the inner pipe. The entry end of inner pipe 12 is joined to outer pipe 14 as shown in FIG. 1 and a filter screen 16 of copper mesh shown in FIGS. 1 and 2 is fitted into the enlarged entrance end of inner pipe 12 in order to prevent the intrusion into Ion Colliders 10 and 20 of gravel or other large particles.

Regardless of the diameter of outer pipe 14, the inner surface of outer pipe 14 is preferably spaced about one and one half inches from the outer surface of inner pipe 12. Both inner and outer pipes 12 and 14 shall be coated with titanium oxide. Preferably pipes 12 and 14 are made of black iron or other suitable ferrous metal and the outer surface of pipe 12 and the inner surface of pipe 14 are coated with a titanium alloy or titanium oxide.

The titanium coating shall be exposed to a means of ultraviolet light and may be centrally displaced within the inner pipe 12 and or positioned at one or both ends of the Ion Collider for the purpose of irradiation to create a photocatalyst effect.

We have constructed and successfully operated Ion Colliders in which the diameter of pipe 14 ranges from 4 to 14 inches. But in all these Ion Colliders the distance between the outer surface of pipe 12 and the inner surface of pipe 14 was about one and one half inches, thereby creating an annular chamber 15 between pipes 12 and 14 whose surfaces consist of a alloy promoting ion exchange.

Liquid containing immiscible particles are pumped through filter screen 16 into pipe 12 causing a multiplicity of jets of the particle-containing liquid to issue from pipe 12 into the chamber 15 to bombard the titanium oxide coated wall of pipe 14.

Electrons freed from the walls of annular chamber 15 combine with both the liquid molecules and the particle molecules, causing the particles to separate from the liquid.

We prefer using pipes made of black iron and coating the outer surface of pipe 12 and the inner surface of pipe 14 with ion exchanging alloy for two reasons. A coated pipe has a roughened irregular surface, thus presenting more surface area to the turbulent action of the liquid in chamber 15 and causing the creation of more electrons surrendered from the surface of the copper.

To increase turbulence in chamber 15 between inner pipe 12 and outer pipe 14, a helix of copper or copper-nickel alloy wire 17 is wrapped between the outer surface of inner pipe 12 and the inner surface of outer pipe 14 from one end of the chamber to the other. Helical wire 17 preferably has a diameter of at least 1/16 of an inch and is wound with a frequency of not less than ¼ of an inch and not more than 1 inch apart measured longitudinally along the axis of pipe 12. Helical wire may be coated with a titanium oxide for additional photocatalyst effect.

The liquid and particles having been treated in Ion Collier 10 are then passed through U-shaped deceleration tube 18. The function of tube 18 is to create an abrupt decrease in the momentum of the stream exiting from Ion Collider 10. The cross sectional area of tube 18 is equal to or greater than the cross sectional area of inner pipe 12 of Ion Collider 10.

After passing through tube 18 the liquid stream enters Ion Collider 20 which in most respects is identical with Ion Collider 10. However, Ion Collider 20 for obvious reasons does not need a filter screen. The function of Ion Collider 20 is to further enhance the separation of the solid or liquid particles from the liquid base so that these particles can be expeditiously removed from the liquid base soon after they emerge from the discharge end 22 of Ion Collider 20.

As an example of the effectiveness of our Ion Collider, when it is used to treat a mixture or emulsion of oil particles in water, the decanted oil contains less than 1% water and the separated water about 10 parts oil per billion parts water.

While we have illustrated and described preferred embodiments of our invention, such disclosure should not be regarded as any limitation of the scope of our invention. The scope of our invention is defined in the appended claims.

We claim:

1. Apparatus for pre-treating a liquid-based mixture or emulsion containing immiscible particles to enhance the subsequent separation of the particles from the liquid comprising
a first elongated metal pipe having an entry end and an exit end and a plurality of identical spaced apart holes in wall of the pipe,
a cap enclosing the exit end of the pipe,
a second elongated metal pipe having an entry end and an exit end whose inner diameter is greater than the outer diameter of the first pipe and is in axial alignment with and surrounds the first pipe,
the first and second pipes being made of metal,
the inner surface of the outer cylinder and the outer surface of the inner cylinder consisting of a titanium oxide coating, end
means for joining together in axial alignment the entry ends of the first and second pipes whereby the subsequent separation of the particles from the liquid in the liquid-bases mixture or emulsion is enhanced.

2. Apparatus as set forth in claim 1 which a ultraviolet in-line filter is in front of the ion collider.

3. Apparatus as set forth in claim 1 which a ultraviolet in-line filter is the connection means between the first and second ion collider chambers.

4. Apparatus as set forth in claim 1 which a ultraviolet in-line filter is in immediately following the ion colliders.

5. Apparatus as set forth in claim 1 which includes a copper and nickel alloy wire wound around the outside of the first pipe in the form of a helix.

6. Apparatus as set forth in claim 1 which includes a copper and nickel alloy wire inserted in the form of a helix inside the interior pipe.

7. Apparatus as set forth in claim 1 in which both the first and second pipes are made of a titanium alloy.

8. Apparatus as set forth in claim 1 in which the distance between the inner pipe and the outer pipe is approximately one and one half inches.

9. Apparatus as set forth in claim 1 in which the cap has a hole lying along the axis of the first metal pipe and the hole has a diameter slightly larger than the diameter of the holes in the wall of the first pipe.

10. Apparatus as set forth in claim 1 in which the second pipe is made of black iron and its inner surface is spatter coated with titanium oxide.

11. Apparatus for pre-treating a water-based mixture or emulsion containing particles of oil to enhance the subsequent separation of the oil from the water by decanting comprising
a first elongated pipe having an entry end and an exit end and a plurality of spaced apart holes in the wall of the pipe,
a cap enclosing the exit end of the pipe,
a second elongated pipe having an entry end and an exit end whose inner diameter is greater than and spaced from the outer wall of the first pipe and is in axial alignment with and surrounds the first pipe,
the inner surface of the outer pipe and the outer surface of the inner pipe being coated with an alloy made of copper, nickel and titanium, and
means for joining together in axial alignment the entry ends of the first and second pipes whereby the subsequent separation of the oil particles from the water in the water-based mixture or emulsion is enhanced.

12. Apparatus as set forth in claim 11 in which the first and second pipes are made of iron.

13. Apparatus as set forth in claim 11 in which the first and second pipe is made of copper and coated with titanium oxide.

14. Apparatus as set forth in claim 11 in which the distance between the first and second pipes is about one and one half inches.
